(19) United States
(12) Patent Application Publication
(10) Pub. No.: US 2004/0240218 A1
(43) Pub. Date: Dec. 2, 2004

(54) Light axis adjusting apparatus for vehicle headlamp

(76) Inventors: Kenji Hayashi, Tokyo (JP); Masayuki Kayano, Tokyo (JP)

Correspondence Address: ROSSI & ASSOCIATES, P.O. BOX 826, ASHBURN, VA, 20146-0826, US

(21) Appl. No.: 10/803,536

(22) Filed: Mar. 18, 2004

(30) Foreign Application Priority Data
Mar. 18, 2003 (JP) 2003-73137

(51) Int. Cl. B60Q 1/08

(52) U.S. Cl. 362/466; 362/467

(57) ABSTRACT

According to a light axis adjusting apparatus for a vehicle headlamp, the inclined state (inclination angle Δα) of a vehicle, when stopping, relative to a road surface is detected. The amount of change of the inclined state is computed based on the inclined state (inclination angle Δα) of the vehicle. When this amount of change becomes a specified value or more, the amount of change is added to or subtracted from the current inclination angle Δα to update the data. Based on a new inclination angle Δα after updating, an actuator is driven to correct the inclination angle of the headlamp. Thus, the inclined state of the vehicle is detected with high accuracy, and the light axis of the headlamp can be adjusted appropriately.

The entire disclosure of Japanese Patent Application No. 2003-73137 filed on Mar. 18, 2003, including specification, claims, drawings and summary, is incorporated herein by reference in its entirety.

### BACKGROUND OF THE INVENTION

1. Field of the Invention

This invention relates to a light axis adjusting apparatus for adjusting the light axis of a headlamp according to the inclined state of a vehicle. This invention is preferred, particularly when applied to a truck having a cab and a cargo bed provided on a frame.

2. Description of the Related Art

In recent years, high intensity lamps have been adopted from the viewpoint of safety. High intensity lamps contribute greatly to safety, but are highly likely to be dazzling to other vehicles. Thus, studies have been conducted on technologies for adjusting the light axis of a headlamp according to the inclined status of a vehicle so as not to dazzle the driver of an oncoming vehicle.

Japanese Patent Application Laid-Open No. 1998-166933, hereinafter referred to as Patent Document 1, proposes such a light axis adjusting apparatus for adjusting the light axis of a headlamp according to the inclined status of a vehicle.

“A vehicle headlamp light axis direction automatic adjusting apparatus” described in Patent Document 1 calculates a pitch angle in a longitudinal direction of a vehicle based on signals from height sensors disposed on front and rear wheels of the vehicle; and performs filtering of the pitch angle in a driving state control mode set based on a vehicle speed and acceleration to change the response of adjustment of the light axis direction of headlamps so as not to dazzle an oncoming vehicle.

In the above apparatus of Patent Document 1, a pair of height sensors (front and rear ones) for measuring the amounts of change in the front and rear vehicle heights are used to detect the inclination of the vehicle. When this conventional apparatus is applied to a truck or the like having a cab and a cargo bed provided on a frame, the amounts of displacement between the front or rear axle and the frame are detected, and the inclined status of the cab is determined by the difference between the front and rear displacements. Based on this determination, the light axis of theheadlamp is adjusted.

In the truck having the cargo bed provided on the frame, however, the frame is deflected under a load of a cargo, thus making it difficult to determine the inclined status accurately. That is, depending on the position of the cargo, the vertical strokes between the front and rear axles and the frame may be nearly the same, although the frame is deflected and a front end portion of the frame (a portion on the cab side) is inclined upwards. In this case, the light axis of the headlamp needs to be adjusted so as to be downward. However, it may be determined that there is no inclined state, and this may make it impossible to adjust the light axis of the headlamp.

### SUMMARY OF THE INVENTION

The present invention has been accomplished in the light of the above-mentioned circumstances. It is the object of the invention to provide a light axis adjusting apparatus for a headlamp, which can detect the inclined state of a vehicle with high accuracy and adjust the light axis of the headlamp appropriately.

A light axis adjusting apparatus for a vehicle headlamp, as a first aspect of the present invention for attaining the above object, comprises: a light axis adjustor for adjusting the light axis of the headlamp of a vehicle; an operating state detector for detecting the operating state of the vehicle; an inclined state detector for detecting the inclined state of the vehicle relative to a road surface; a change amount computing unit for computing the amount of change of the inclined state during a halt of the vehicle based on the results of detection of the inclined state detector when the operating state detector detects the stop state of the vehicle; and a control device for controlling the light axis adjustor based on the results of detection of the inclined state detector and the results of computation of the change amount computing unit.

According to this aspect, while the vehicle is stopping, the control device controls the light axis adjustor based on the inclined state of the vehicle and the amount of change of this inclined state. In this case, the inclined state of the vehicle which is stopping can be detected with high accuracy, regardless of the condition of the road surface, whereby the light axis of the headlamp can be adjusted appropriately.

According to the light axis adjusting apparatus for a vehicle headlamp, as a second aspect of the invention, the change amount computing unit may include: an average value calculator for calculating average values by performing moving average processing of the results of detection of the inclined state detector; a memory device for storing convergent average values obtained when the average values converge within a predetermined range; and an inclined state change amount setting device for setting the difference between the maximum value and the minimum value of the convergent average values as the amount of change of the inclined state.

According to this aspect, variation component data in the results of detection of the inclined state detector are removed, so that the amount of change of the inclined state can be obtained more appropriately.

According to the light axis adjusting apparatus for a vehicle headlamp, as a third aspect of the invention, the control device may include an updating device for updating the results of detection of the inclined state detector by adding the amount of change to, or subtracting the amount of change from, the results of detection when the amount of change is not less than a set amount of change which has been preset.

According to this aspect, variation component data in the results of detection of the inclined state detector are removed, so that more accurate inclination data can be obtained.

According to the light axis adjusting apparatus for a vehicle headlamp, as a fourth aspect of the invention, the operating state detector may include an average value computing unit for computing an average value of the inclined state during driving based on the results of detection of the inclined state detector when the operating state detector detects the driving state of the vehicle, and the control device may control the light axis adjustor based on the results of detection of the inclined state detector and the results of computation of the average value computing unit.

According to this aspect, the control device controls the light axis adjustor based on the inclined state of the vehicle, and the average value of the inclined state while the vehicle is running. Thus, the inclined state of the vehicle, which is running, is detected highly accurately, regardless of the irregularities of the road surface, a roadblock, or a protrusion, so that the light axis of the headlamp can be adjusted appropriately.

According to the light axis adjusting apparatus for a vehicle headlamp, as a fifth aspect of the invention, the average value computing unit may include: a collector for collecting a specified number or more of the results of detection of the inclined state detector during driving; a standard deviation calculator for calculating a standard deviation based on the results of collection; and a setting device for setting the average value of the results of collection as an inclined state average value during driving when the standard deviation is not more than a set standard deviation which has been preset, and the control device may include an updating device for updating the results of detection of the inclined state detector to the average value.

According to this aspect, variation component data in the results of detection of the inclined state detector are removed, so that more accurate inclination data can be obtained.

According to the light axis adjusting apparatus for a vehicle headlamp, as a sixth aspect of the invention, there may be further provided a standard deviation calculator for collecting a specified number or more of the results of detection of the inclined state detector and calculating a standard deviation when the operating state detector detects the stop state of the vehicle; and an average value computing unit which, when the standard deviation has been judged to be not greater than a set standard deviation that has been preset, computes the average value of the results of detection for which the standard deviation has been judged to be not greater than the set standard deviation, and the control device may include an updating device which updates the results of detection of the inclined state detector to the average value computed by the average value computing unit when the standard deviation is not greater than the set standard deviation, and which adds the amount of change to, or subtracts the amount of change from, the results of detection of the inclined state detector to update the results of detection, when the standard deviation is greater than the set standard deviation.

According to this aspect, the method of setting inclination angle data is changed depending on whether the condition of the road surface is uneven or flat. Thus, an appropriate method of computation is used according to the road condition, so that inclination angle data can be set swiftly with high accuracy.

According to the light axis adjusting apparatus for a vehicle headlamp, as a seventh aspect of the invention, the inclined state detector may include: an inclination sensor for detecting the inclination angle of the vehicle relative to the road surface; and a filter device for removing high frequency components of data on the inclination angle detected by the inclination sensor.

According to this aspect, high frequency components of inclination angle data obtained when the vehicle is stopping are removed. As a result, unique component data generated by the irregularities of the road surface, a road block or a protrusion or loading or unloading of a cargo are excluded, so that more accurate inclination data can be obtained.

According to the light axis adjusting apparatus for a vehicle headlamp, as an eighth aspect of the invention, the inclination sensor may be an ultrasonic sensor having a transmitter and a receiver.

According to this aspect, the inclined state of the vehicle can be detected with high accuracy, without influence of deformation of the vehicle or tire.

According to the light axis adjusting apparatus for a vehicle headlamp, as a ninth aspect of the invention, the transmitter and the receiver may be a pair of ultrasonic sensors placed in a vehicle width direction, and a plurality of the pairs of ultrasonic sensors may be disposed in a longitudinal direction of the vehicle.

According to the light axis adjusting apparatus for a vehicle headlamp, as a tenth aspect of the invention, the inclined state detector may be a laser sensor.

According to the light axis adjusting apparatus for a vehicle headlamp, as an eleventh aspect of the invention, the vehicle may be a truck furnished with a cab and a frame where the cab is disposed, and the inclined state detector may be placed on the cab or a vehicle front portion of the frame.

A light axis adjusting apparatus for a vehicle headlamp, as a twelfth aspect of the invention, comprises: light axis adjusting means for adjusting the light axis of the headlamp of a vehicle; operating state detecting means for detecting the operating state of the vehicle; inclined state detecting means for detecting the inclined state of the vehicle relative to a road surface; change amount computing means for computing the amount of change of the inclined state during a halt of the vehicle based on the results of detection of the inclined state detecting means when the operating state detecting means detects the stop state of the vehicle; and control means for controlling the light axis adjusting means based on the results of detection of the inclined state detecting means and the results of computation of the change amount computing means.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic configuration drawing of a truck equipped with a light axis adjusting apparatus for a vehicle headlamp according to a first embodiment of the present invention;

FIG. 2 is a plan view of a frame of the truck;

FIG. 3 is a schematic view of a front portion of the frame showing the state of mounting of an ultrasonic sensor;

FIG. 4 is a sectional view taken on line IV-IV of FIG. 3;

FIG. 5 is a sectional view taken on line V-V of FIG. 4;

FIG. 6 is a schematic view showing the state of mounting of the ultrasonic sensor;

FIGS. 7(a) and 7(b) are explanation drawings of a method for detecting the inclined state of a vehicle;

FIG. 8 is a graph showing transmitted pulses and received pulses of the ultrasonic sensor;

FIG. 9 is a horizontal sectional view of a headlamp portion mounted with the light axis adjusting apparatus for the vehicle headlamp;

FIG. 10 is a sectional view taken on line X-X of FIG. 9;

FIG. 11 is a control block chart for the light axis adjusting apparatus for the vehicle headlamp in the first embodiment;

FIG. 12 is a flow chart for initialization by the light axis adjusting apparatus for the vehicle headlamp in the first embodiment;

FIG. 13 is a flow chart for adjustment and control by the light axis adjusting apparatus for the vehicle headlamp in the first embodiment;

FIG. 14 is a graph showing changes in inclination angle data during driving and halt of the vehicle;

FIG. 15 is a graph showing changes in sensor values and average values of the inclination angle data; and

FIG. 16 is a flow chart for adjustment and control by a light axis adjusting apparatus for a vehicle headlamp according to a second embodiment of the present invention.

### DETAILED DESCRIPTION OF THE PREFERRED EMBODIMENTS

The preferred embodiments of the present invention will now be described in detail with reference to the accompanying drawings.

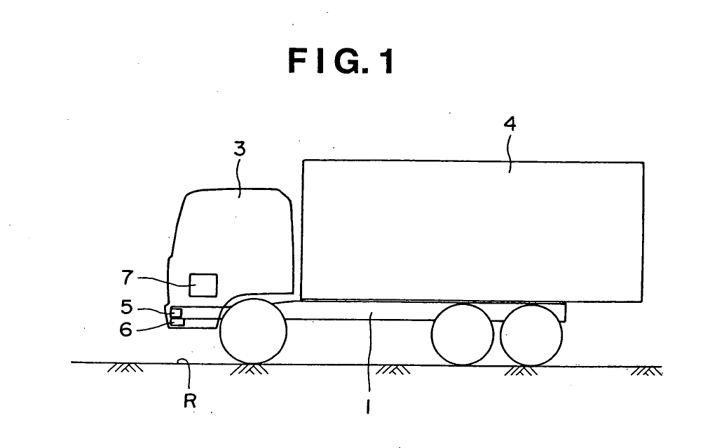

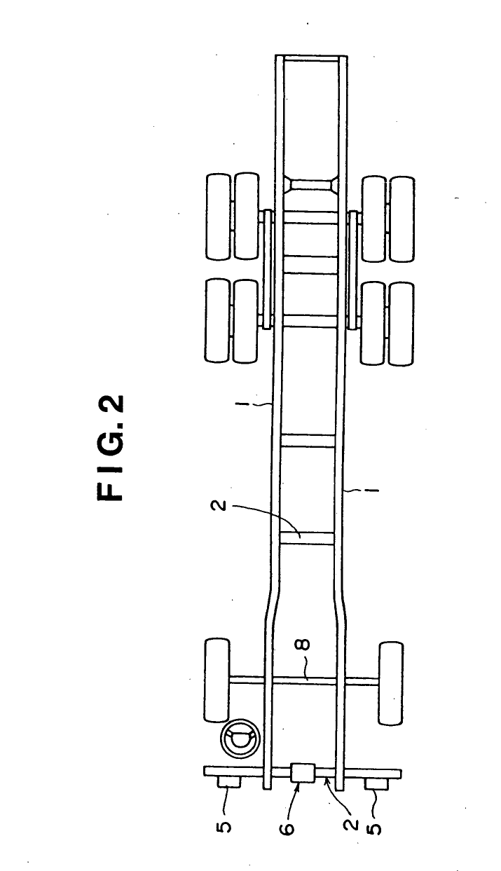

In a light axis adjusting apparatus for a vehicle headlamp according to a first embodiment of the invention, a plurality of cross members 2 are assembled to, while being perpendicular to, a pair of (i.e. right and left) side frames 1, and a cab 3 and a cargo bed 4 are loaded on a frame composed of the side frames 1 and the cross members 2, as shown in FIGS. 1 and 2. Right and left headlamps 5 are mounted on both sides of the cross member 2 in a front end portion of a vehicle, and an inclination sensor 6, as an inclination detector, is disposed in a nearly central portion of this cross member 2. Detection signals from the inclination sensor 6 are entered into an ECU 7 as a control device, and the ECU 7 determines an inclined state of a front portion of the vehicle relative to a road surface based on detection information from the inclination sensor 6.

The right and left headlamps 5 may be provided on the cab 3. The inclination sensor 6 may be provided on an upper side rail of the front axle 8, or if provided forwardly of the front axle 8, may be provided in an end portion of the vehicle other than the cross member 2 (for example, on the cab 3).

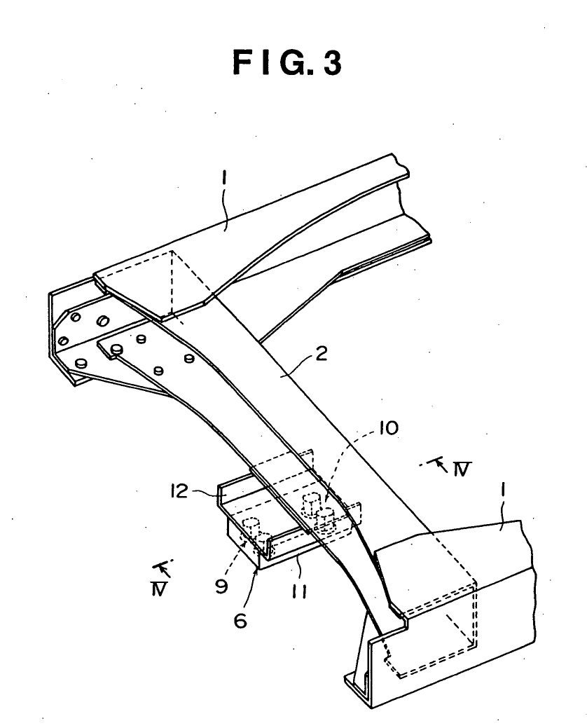

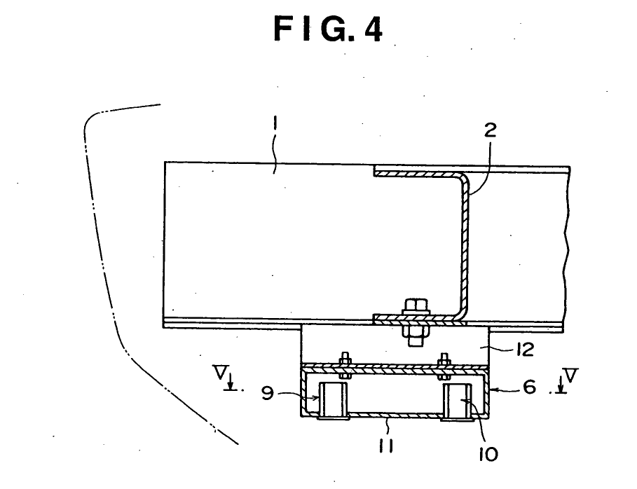

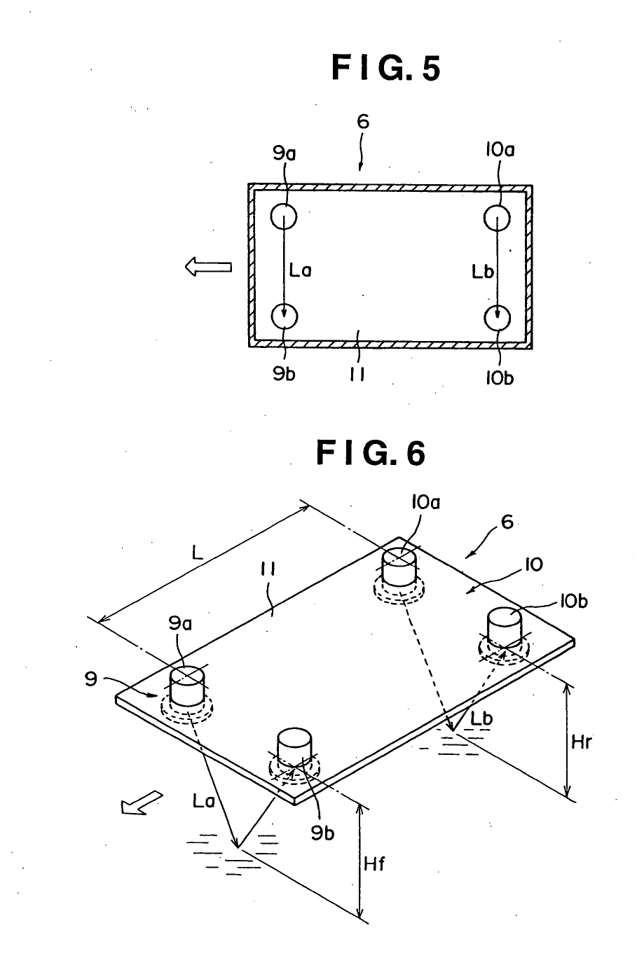

The inclination sensor 6 will be describe in detail. As shown in FIG. 3 to 6, the inclination sensor 6 comprises two ultrasonic sensors 9 and 10 for transmitting and receiving signals in a vehicle width direction, and has two transmitters 9a and 10a as a signal transmitting portion, and two receivers 9b and 10b as a signal receiving portion. The transmitters 9a, 10a are disposed on the right side of the vehicle, while the receivers 9b, 10b are disposed on the left side of the vehicle. The directions of transmitted and received waves of the respective ultrasonic sensors 9 and 10 are nearly parallel to each other, and are nearly perpendicular to the longitudinal direction of the vehicle. The positions of mounting of the transmitters 9a, 10a and the receivers 9b, 10b may be laterally reversed.

The ultrasonic sensors 9, 10 are housed in a box-shaped case 11 such that transmitting and receiving surfaces in their lower portions are exposed. The case 11 is mounted to an intermediate portion of the cross member 2 via a U-shapedbracket 12, so that the inclination sensor 6 is mounted on a front portion of the vehicle in opposed relationship with the road surface R. By this procedure, the mounting space for the inclination sensor 6 can be shortened in the longitudinal direction of the vehicle. By housing the ultrasonic sensors 9, 10 in the case 11, moreover, the inclination sensor 6 can be made compact, and can be easily mounted on the cross member 2.

Two of the ultrasonic sensors, 9 and 10, are provided anteriorly and posteriorly such that the transmitters 9a, 10a and the receivers 9b, 10b are separate members. However, this feature is not restrictive, and three of the ultrasonic sensors may be provided. Also, the transmitter and the receiver may be integrally assembled, and two of the transmitter-receiver assemblies may be provided forward and rearward. Alternatively, two receivers may be provided for one transmitter so as to be zigzag in the vehicle width direction or in the longitudinal direction of the vehicle. If there is an ample space for mounting, the transmitters and the receivers can be disposed in a row along the longitudinal direction of the vehicle. Furthermore, a laser sensor may be applied as the inclination sensor 6 instead of the ultrasonic sensor.

The inclination sensor 6 detects, for determination, the inclined state of the vehicle relative to the road surface R based on the difference in the receiving time between the two ultrasonic sensors 9 and 10. Ultrasonic waves from the transmitters 9a, 10a are reflected by the road surface R and received by the receivers 9b, 10b. Based on the difference between the receiving times of the receivers 9b and 10b, the inclined state of the vehicle relative to the road surface R is detected and determined. That is, signals from the transmitters 9a, 10a and signals of the receivers 9b, 10b are entered into the ECU 7, and the inclined state of the front cross member 2 (the inclined state of the front of the vehicle) relative to the road surface is determined by the ECU 7 based on the difference between the times when the receivers 9b, 10b receive ultrasonic waves. The inclination sensor 6 is designed to detect, for determination, the inclined state of the vehicle relative to the road surface R based on the difference in the receiving time. However, the inclined state of the vehicle relative to the road surface R may be detected and determined based on the difference in received phase.

The method of detecting, for determination, the inclined state of the vehicle by the inclination sensor 6 will be described in detail with reference to FIGS. 6 to 8.

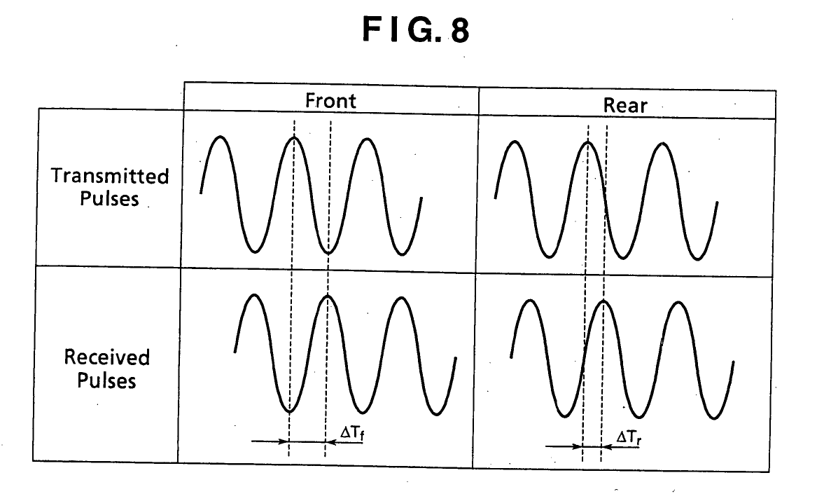

As shown in FIG. 8, the front and rear transmitters 9a and 10a in the ultrasonic sensors 9, 10 transmit wave-shaped ultrasonic pulses, while the front and rear receivers 9b and 10b receive the wave-shaped ultrasonic pulses, which have been transmitted by the transmitters 9a and 10a, with predetermined delays. Thus, transmitting-receiving time differences ΔTf and ΔTr occur, and a receiving time difference ΔT is calculated based on the transmitting-receiving time differences ΔTf and ΔTr. From the result of calculation, an inclination angle Δα of the vehicle is found.

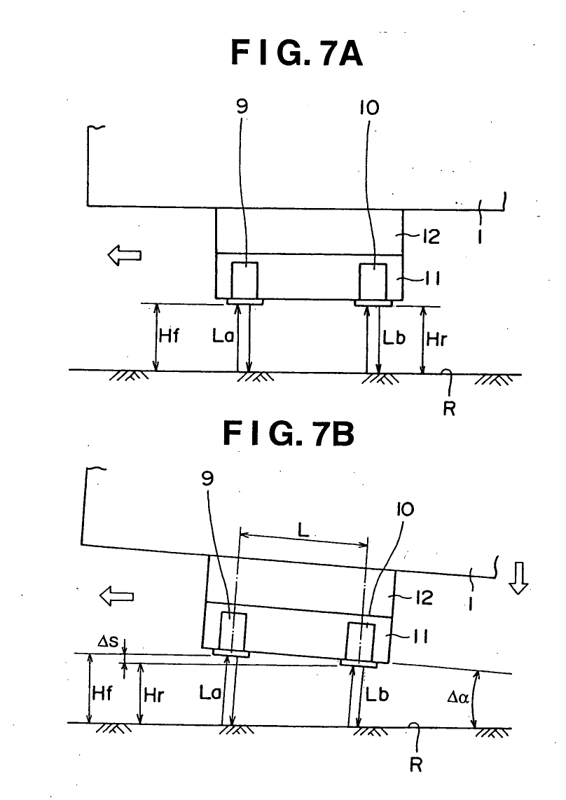

That is, as shown in FIG. 6 and FIG. 7(a), when the front portion of the vehicle (the front cross member 2) does not incline relative to the road surface R, the front and rear detected heights Hf and Hr are equal. Thus, a path La of an ultrasonic wave, which is transmitted from the front transmitter 9a to the front receiver 9b, is equal to a path Lb of an ultrasonic wave, which is transmitted from the rear transmitter 10a to the rear receiver 10b (i.e. ΔTf=ΔTr). As a result, the receiving time difference ΔT=(ΔTf−ΔTr)/2 between the front and rear receivers 9b and 10b is zero.

As shown in FIG. 6 and FIG. 7(b), on the other hand, assume that a cargo is loaded on the cargo bed 4, whereby the rear portion of the vehicle sinks, making the front portion of the vehicle inclined rearward (upward) relative to the road surface R. In this case, the front and rear detected heights Hf and Hr are different. Thus, the path La of an ultrasonic wave, which is transmitted from the front transmitter 9a to the front receiver 9b, is longer than the path Lb of an ultrasonic wave, which is transmitted from the rear transmitter 10a to the rear receiver 10b (i.e. ΔTf>ΔTr). As a result, the receiving time difference ΔT occurs between the front and rear receivers 9b and 10b.

When the front portion of the vehicle is inclined rearward, as noted above, a distance difference AS occurs in the height direction between the transmitters 9a and 10a separated by a distance L. This distance difference ΔS can be found from the equation (1), indicated below, based on the receiving time difference ΔT, ambient temperature and sound velocity. In this equation, K denotes a coefficient based on ambient temperature and sound velocity. Inclination angle Δα can be calculated from the equation (2), indicated below, based on the distance difference ΔS and the longitudinal distance L between the receivers 9b and 10b.

ΔS=(Hf−Hr)=ΔT×K (1)

Δα=tan−1(ΔS/L) (2)

Thus, the ECU 7 can determine the inclined state of the vehicle by deriving the distance difference ΔS based on the receiving time difference ΔT between the receivers 9b and 10b, and calculating the inclination angle Δα from the above-mentioned equation (2).

In contrast to what is shown in FIG. 7(b), assume that a cargo is loaded on the cargo bed 4, whereby the front portion of the vehicle sinks, making the front portion of the vehicle inclined forward (downward) relative to the road surface R. In this case, the path Lb is longer than the path La. As a result, the receiving time difference ΔT occurs between the front and rear receivers 9b and 10b. In the same manner as described above, the inclination angle Δα is calculated from the aforementioned equation (2), whereby the inclined state of the vehicle can be determined.

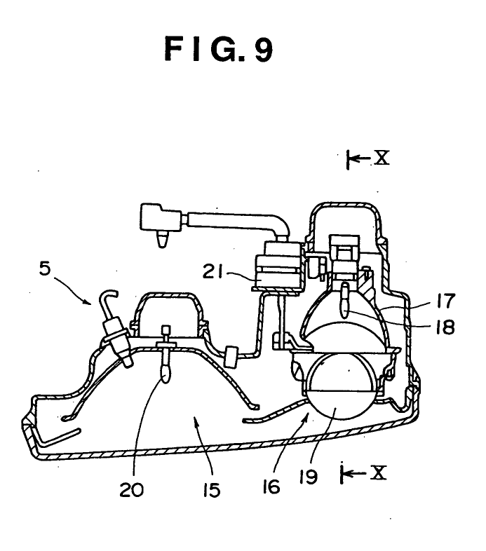

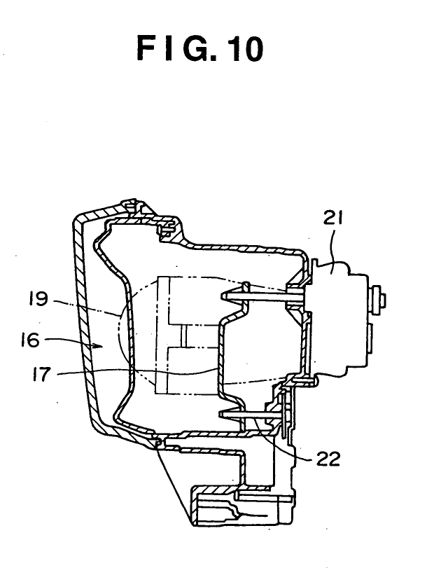

The headlamp 5 and a light axis adjusting apparatus for it will be described with reference to FIGS. 9 and 10.

As shown in FIGS. 9 and 10, the headlamp 5 is composed of a high-beam lamp 15 and a low-beam lamp 16, and the low-beam lamp 16 is, for example, a high intensity lamp (e.g. a discharge headlamp). The low-beam lamp 16 comprises a high intensity bulb 18 mounted on a reflector holder 17, and has a condenser lens 19. The high-beam lamp 15 has, for example, a halogen bulb 20. The high intensity bulb 18 is tilted, together with the reflector holder 17, by an actuator 21 as a light axis adjusting apparatus, to have its light axis adjusted vertically. The actuator 21 is driven by a command issued by the ECU 7 according to the inclined state determined by the ECU 7 based on the information from the inclination sensor 6. As a result, the light axis of the high intensity bulb 18 is adjusted.

The low-beam lamp 16 is also provided with a manual screw 22 with which to adjust the reflector holder 17 manually, thereby adjusting the light axis of the high intensity bulb 18. The manual screw 22 is used to set the position of the light axis of the high intensity bulb 18 with respect to the initial value of the inclination sensor 6.

It is also possible to adjust the high-beam lamp 15 vertically by the actuator 21 in the same manner as for the low-beam lamp 16. The headlamp is also available as a structure composed of the reflector and the bulb integrated together. If the reflector holder and the bulb are integral, the light axis of the bulb can be adjusted by tilting the reflector holder by the actuator.

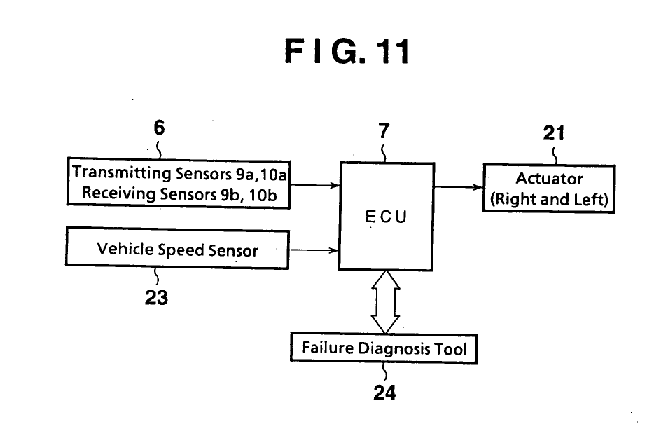

With the light axis adjusting apparatus for the vehicle headlamp according to the present embodiment configured as above, the ECU 7 receives information from a vehicle speed sensor 23 as an operating state detector, and also receives detection signals from the inclination sensor 6 (transmitters 9a, 10a and receivers 9b, 10b), as shown in FIG. 11. The ECU 7 determines the halt state or driving state of the vehicle based on the vehicle speed detected by the vehicle speed sensor 23, and also computes the aforementioned inclination angle Δα based on the detection results from the transmitters 9a, 10a and the receivers 9b, 10b. A drive command is issued to the actuator (the actuator for the right and left headlamps 5) 21 for tilting the reflector holder 17, whereby the light axis of the high intensity bulb 18 is adjusted into a predetermined state based on the status and the inclined state of the vehicle.

The ECU 7 is also furnished with the function of using the results of the inclination angle Δα, present when the vehicle is empty and on a flat road, as the initial value, and issues a command to store the initial value through a detachable failure diagnosis tool 24. The result of the inclination angle Δα, obtained when the vehicle is empty and on a flat road, is taken up as the initial value and, in this condition, the light axis of the high intensity bulb 18 is adjusted to a predetermined state by the manual screw 22. Based on the initial value stored, the actuator 21 is driven according to the inclination angle Δα computed from the information fed by the inclination sensor 6 to adjust the light axis of the high intensity bulb 18 in accordance with the inclined state.

According to the above feature, even if variations exist in the detection status of the inclination sensor 6, it is possible to evaluate the inclined state always with constant accuracy and adjust the light axis of the high intensity bulb 18. Furthermore, the command is issued to store the initial value by the failure diagnosis tool 24. Thus, initialization can be performed easily by utilizing the existing device.

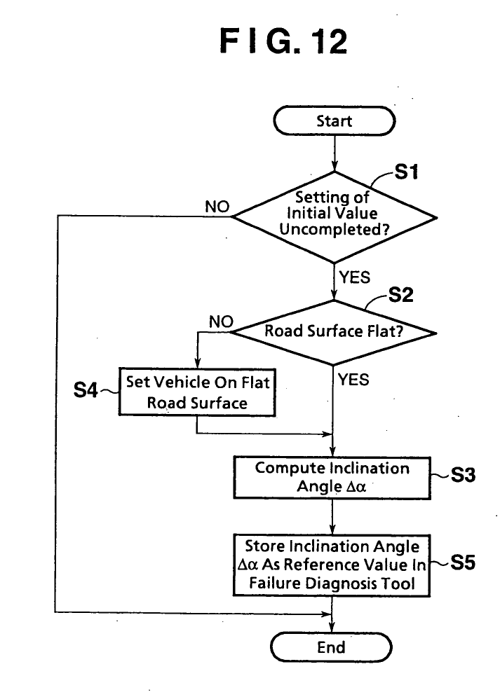

That is, at the time of shipment of the vehicle from the factory, it is determined in step S1 whether setting of the initial value has been completed or not, as shown in FIG. 12. If a determination is made that setting of the initial value has not been completed, whether the road surface is flat or not is determined in step S2. When it is determined in step S2 that the road surface is flat, the inclination angle Δα is computed in step S3 based on detected information from the transmitters 9a, 10a and the receivers 9b, 10b. In step S5, a command is issued to store the inclination angle Δα, computed at that time, as the initial value in the failure diagnosis tool. As a result, the initial value is stored in the ECU 7. If it is determined in step S2 that the road surface is not flat, the vehicle is set on the flat road surface in step S4, and the program proceeds to step S3. When it is determined in step S1 that setting of the initial value has been completed, the program ends at this stage.

The initial value may be stored not by the failure diagnosis tool 24, but by an initial value switch provided on the vehicle body, or by the insertion and extraction of a harness connector.

After the inclination angle Δα computed from the detected information from the transmitters 9a, 10a and the receivers 9b, 10b on the flat road surface is set as the initial value, the high intensity bulb 18 is tilted, together with the reflector holder 17, by the manual screw 22 to adjust the light axis of the high intensity bulb 18 to the state of the light axis on the flat road surface. By so doing, it becomes possible to exercise control according to the detected information from the inclination sensor 6 based on the inclination angle Δα computed for the flat road (auto-leveling).

At the time of vehicle shipment from the factory, auto-leveling is started. On this occasion, the inclined state of the vehicle at a standstill and the inclined state of the vehicle during driving (for example, at 40 km/h or more) are detected. The ECU 7 drives the actuator 21 based on the information from the inclination sensor 6 to adjust the light axis of the high intensity bulb 18.

According to the present embodiment, when the road surface is rough, or the vehicle drives over a road block or a protrusion, data on the inclined state may respond to this situation, making accurate detection impossible. Thus, high frequency components (for example, frequency components exceeding 0.1 Hz) of the data on the inclined state are removed (filter device). When many data on the inclined state are collected, and the respective frequency components are examined for deviation, data as high frequency components (for example, data as frequency components exceeding 0.1 Hz) have been confirmed to have sharply increased deviations. Thus, data as high frequency components are removed. This treatment enables the inclined state to be determined by data with relatively small deviations, namely, by data excluding situations where the road surface has irregularities or the vehicle drives over a road block or protrusion.

When the vehicle is during a halt, it is determined whether a cargo has been loaded or unloaded. When there has been loading or unloading, the amount of change in data due to loading or unloading is computed, and this amount of change is added to or subtracted from the existing data on the inclined state to update the data.

That is, while the vehicle is stopping, proper data on the inclined state cannot be obtained, if there is a road seam, a road block or a protrusion on the road surface detected by the inclination sensor 6. Thus, data on the inclined state are collected, and processed by the moving average method. When the average values obtained by this processing converge within a predetermined range, the convergent average values are stored in memory. The difference between the maximum value and the minimum value of the convergent average values is set as an amount of change in the data on the inclined state (change amount calculator). When this amount of change is not smaller than a set amount of change which has been preset, this amount of change is added to or subtracted from the current inclination angle data to update the data. During a halt of the vehicle, the collected data are confirmed to vary within a narrow range because of the occupant's ingress or egress or engine vibrations. When the cargo is loaded or unloaded, on the other hand, the collected data are confirmed to vary within a wide range.

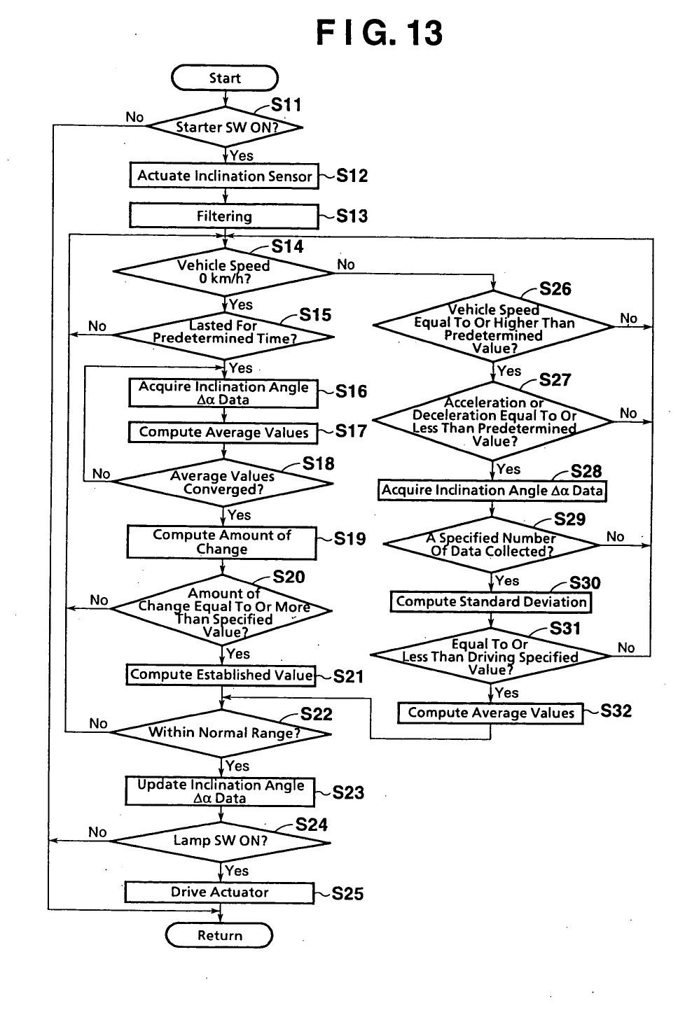

The method of updating vehicle inclination angle data by the light axis adjusting apparatus for a vehicle headlamp according to the first embodiment will be described in detail with reference to FIGS. 13 to 15.

As shown in FIG. 13, when auto-leveling is started, it is determined in step S11 whether a starter SW is on or not. Upon determination that the starter SW is on, the inclination sensor 6 is actuated in step S12 to compute the inclination angle Δα. After computation of the inclination angle Δα in step S12, filtering is executed in step S13 for removing high frequency components (for example, frequency components exceeding 0.1 Hz) from the data on the inclination angle Δα. This filtering removes data, which are obtained when the road surface has irregularities or the vehicle drives over a road block or protrusion, from the data on the inclination angle Δα. Thus, proper data on the inclined state can be obtained.

In step S14, it is determined whether the vehicle speed is 0 km/h or not. Upon determination that the vehicle speed is 0 km/h, it is determined in step S15 whether the state of the vehicle speed being 0 km/h has lasted for a predetermined period of time (for example, 5 seconds). Upon determination in step S15 that this state has lasted for the predetermined time, it is determined that the vehicle is stopping. In this case, data on the inclination angle Δα during a vehicle halt is acquired in step S16. If it is determined in step S15 that the predetermined time has not elapsed, a determination is made that the vehicle is making a temporary stop. In this case, the program goes to step S14 to repeat making a determination about the vehicle speed.

After acquisition of the inclination angle Δα data in step S16, the moving average method is performed in step S17 to compute average values, whenever necessary. In step S18, it is determined whether the computed average values have converged within a predetermined range. If it is determined that the average values have converged within the predetermined range, the converged average values are stored in memory as convergent average values. In step S19, the amount of change between the maximum value and the minimum value of the convergent average values is computed. If a determination is made in step S18 that the average values do not converge within the predetermined range, the program moves to step S16 to repeat its processing. If the convergent average value found in step S18 is only one, the amount of change computed in step S19 is zero.

After computation of the amount of change in step S19, it is determined in step S20 whether the amount of change is equal to or greater than a specified value (set amount of change) which has been preset. If the amount of change is judged to be equal to or greater than the specified value, a determination is made that a cargo has been loaded or unloaded. Thus, the program goes to step S21. Here, the amount of change calculated in step S19 is established as an amount of change for data update. In step S22, a determination of whether the established amount of change is within a normal range or not is made. If a determination is made that data on the amount of change is within the normal range, the amount of change is added to (or subtracted from) the current inclination angle Δα data in step S23 to update the data on the inclination angle Δα.

As described above, it is determined whether the cargo has been loaded or unloaded, with the vehicle stopping. When the cargo has been loaded or unloaded, data on the inclination angle Δα is promptly updated. Regardless of the irregularities of the road surface, data on the inclination angle Δα can be updated reliably and promptly.

After updating of data on the inclination angle Δα in step S23, it is determined in step S24 whether a lamp SW for lighting the headlamp 5 is on or not. If a determination is made that the lamp SW is on, the actuator 21 is driven in step S25 to adjust the light axis of the high intensity bulb 18 to the inclination angle Δα. If it is determined in step S24 that the lamp SW is not on, the state of retention of data on the inclination angle Δα is maintained.

If it is determined in step S14 that the vehicle speed is not 0 km/h, the program goes to step S26 to determine whether the vehicle speed is a predetermined value or higher. The predetermined value is set at a value less than a vehicle speed at which there are many variations in data on the inclined state, for example, set at 40 km/h. When a determination is made in step S26 that the vehicle speed is not less than the predetermined value, step S27 determines whether the acceleration or deceleration of the vehicle is a predetermined value or less. The predetermined value at this time is set at a value which is not deemed to represent an accelerated or decelerated state; for example, it is set at 2 m/S².

Upon determinations in step S26 that the vehicle speed is not less than the predetermined value and in step S27 that the acceleration or deceleration is not more than the predetermined value, data on the inclination angle Δα in the driving state of the vehicle is acquired in step S28. If it is determined in step S26 that the vehicle speed does not exceed the predetermined value, and it is determined in step S27 that the acceleration or deceleration of the vehicle exceeds the predetermined value, the program proceeds to step S14.

After acquisition of data on the inclination angle Aa in step S28, it is determined in step S29 whether a specified number of (for example, 500) data on the inclination angle Δα have been collected or not. If a determination is made that the specified number of the data have been collected, a standard deviation is computed in step S30 based on the collected data. If it is determined in step S29 that the specified number of data have not been collected, the program goes to step S14.

After computation of the standard deviation in step S30, it is determined in step S31 whether the standard deviation is a driving specified value (dispersion angle: e.g. 0.3 deg) or less. Upon determination that the standard deviation is not more than the driving specified value, the program proceeds to step S32. In step S32, computation is made of an average value for the data for which it is determined that the standard deviation is not more than the driving specified value. In step S22, it is determined that data on this average value is within the normal range or not. If it is determined that the average value data is within the normal range, data on the inclination angle Δα is updated in step S23.

As described above, the vehicle is judged to be in a driving state, and data on the inclination angle Δα is updated only when the vehicle is in a driving state. Thus, data on the vehicle at a low speed or during sudden acceleration or deceleration can be excluded, and data on the inclination angle Δα in a driving situation with few variations can be adopted.

Then, similarly to the aforementioned procedure, after data on the inclination angle Δα is updated in step S23, the program goes to step S24. If the lamp SW is judged to be on, the actuator 21 is driven in step S25 to adjust the light axis of the high intensity bulb 18 to the inclination angle Δα.

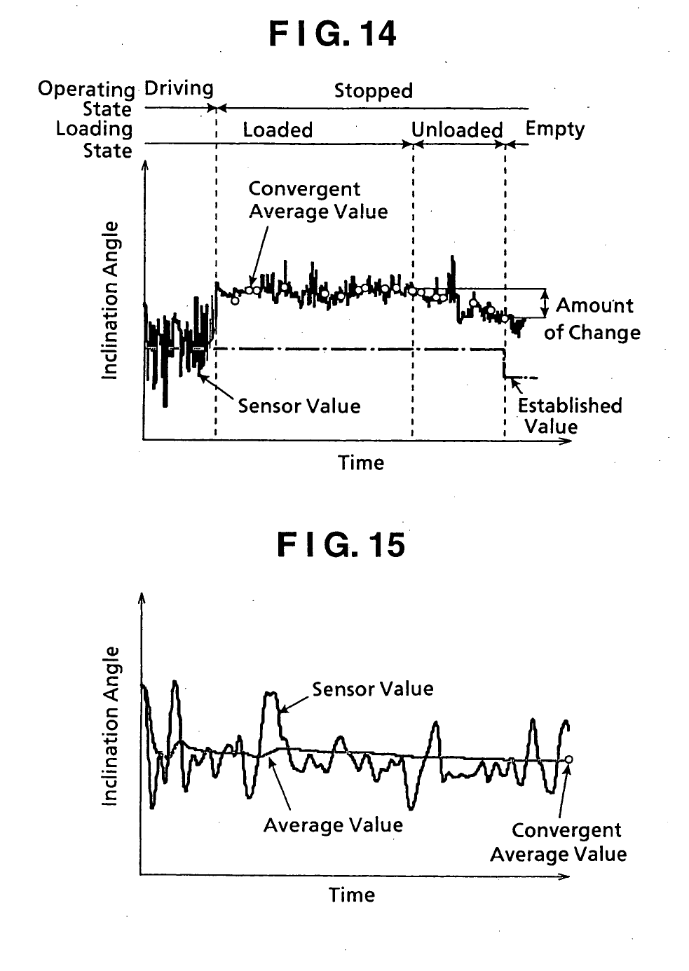

The method of processing data on the inclination angle Δα in the aforementioned vehicle halt state will be described concretely. As shown in FIG. 14, when the vehicle shifts from a driving state to a halt state, the inclination sensor 6 outputs sensor values varying upwardly and downwardly within a predetermined range, regardless of the state of the detected road surface targeted by the inclination sensor 6. The reason is that when the vehicle stops, there are no displacements of the vehicle body according to the state of the road surface. However, the vehicle body is displaced because of ingress and egress of occupants, engine vibrations, etc. On this occasion, the ECU 7 takes in data on the inclination angle Δα, processes the data by the moving average method, and stores those average values, which converge within a predetermined range, as convergent average values. That is, as shown in FIG. 15, the upper and lower peak values of the sensor values outputted by the inclination sensor 6 are sequentially taken in and subjected to moving average processing. If the computed average values converge to a nearly constant level, the average value at this time is taken as a convergent average value, and the convergent average values obtained in this manner are plotted.

This procedure is repeatedly performed to plot a multiplicity of the convergent average values. Based on these convergent average values, the deviation between the maximum value and the minimum value, namely, the amount of change, is computed. If a laden condition (or unloaded condition) continues when the vehicle is at a standstill, the range of upward and downward variations in the sensor values is narrow for the aforementioned reasons. If unloading (or loading) is performed, by contrast, the range of variations in the sensor values is wide, and the convergent average values also vary. Thus, if the amount of change between the maximum value and the minimum value out of the convergent average values is not less than a preset specified value, it is determined that unloading (or loading) has taken place. Using this amount of change as an established value, the current data on the inclination angle Δα is updated. Thus, at a time when unloading is carried out to bring the vehicle into an empty condition, the light axis of the high intensity bulb 18 can be adjusted promptly and properly based on the latest data on the inclination angle Δα.

In the light axis adjusting apparatus for a vehicle headlamp according to the first embodiment, as described above, the inclined state (inclination angle Δα) of the vehicle during a halt relative to the road surface is detected; the amount of change of the inclined state is computed based on the inclined state (inclination angle Δα) of the vehicle; if this amount of change is not less than the specified value, the amount of change is added to or subtracted from the current inclination angle Δα to update the data; and the actuator 21 is driven based on the updated new inclination angle Δα to correct the inclination angle of the headlamp 5.

Thus, loading or unloading of the cargo is determined by the magnitude of the amount of change, with the vehicle stopping, and the inclination angle Δα is updated based on the inclined state and the amount of change to adjust the inclination angle of the headlamp 5. As noted here, regardless of the state of the road surface, the inclined state of the vehicle during halt can be detected with high accuracy, and the light axis of the headlamp can be adjusted appropriately.

While the vehicle is running, when it is determined that the vehicle speed is not less than a predetermined value and the acceleration or deceleration is not more than a predetermined value, the inclined state (inclination angle Δα) of the vehicle is detected. A specified number of data on the inclined state (inclination angle Δα) of the vehicle are collected. If a standard deviation computed based on the collected data is not more than a driving specified value, the average value of the collected data is taken as a new update value of the data on the inclination angle Δα.

Thus, the vehicle is judged to be in a driving state, and data on the inclination angle Δα is updated only while the vehicle is in a driving state. Thus, data on the vehicle at a low speed or during sudden acceleration or deceleration can be excluded, and data on the inclination angle Δα in a driving situation with few variations can be adopted. In this manner, the inclined state of the vehicle while driving can be detected with high accuracy, and the light axis of the headlamp can be adjusted appropriately.

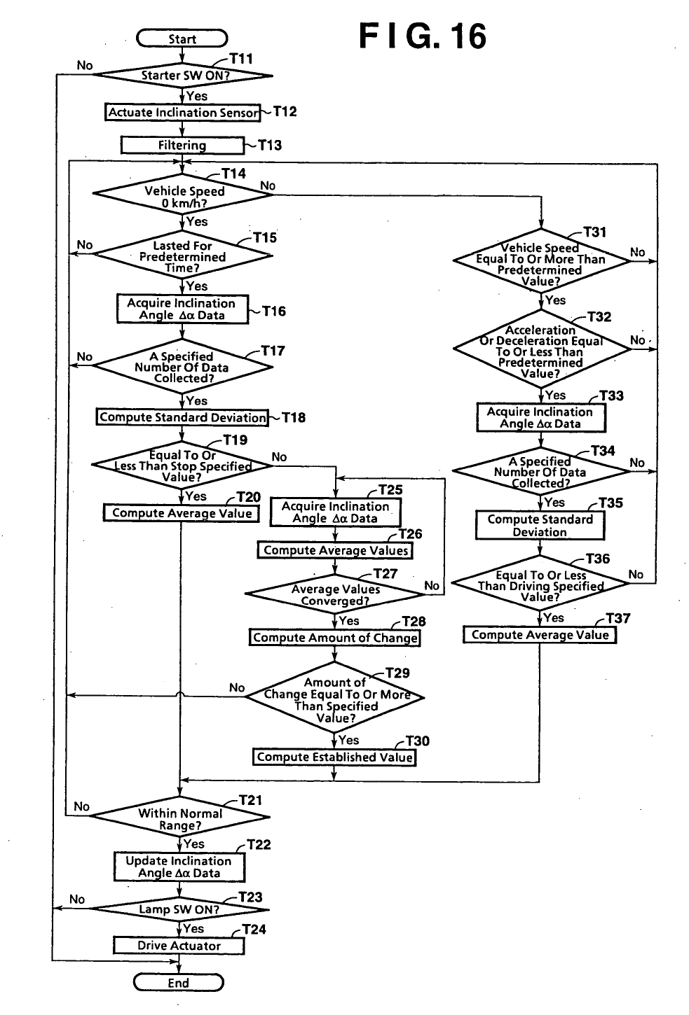

FIG. 16 shows a flow chart for adjustment and control by a light axis adjusting apparatus for a vehicle headlamp according to the second embodiment of the present invention. Members having the same functions as described in the aforementioned embodiment are assigned the same numerals as shown therein, and duplicate explanations are omitted.

In the light axis adjusting apparatus for a vehicle headlamp according to the second embodiment, as shown in FIG. 16, the method of updating data on the inclination angle Δα can be selected depending on the road condition when the vehicle is stopping. That is, if it is determined in step T11 that a starter SW is on, the inclination sensor 6 is actuated in step T12 to compute the inclination angle Δα. In step T13, filtering is executed for removing high frequency components from the data on the inclination angle Δα. If it is determined in step T14 that the vehicle speed is 0 km/h, and if it is determined in step T15 that the state of the vehicle speed being 0 km/h has lasted for a predetermined period of time, the vehicle is judged to be stopping. Based on this judgment, data on the inclination angle Δα during a vehicle halt is acquired in step S16.

After acquisition of data on the inclination angle Δα in step T16, it is determined in step T17 whether a specified number of (for example, 100) data on the inclination angle Δα have been collected or not. If a determination is made that the specified number of the data have been collected, a standard deviation is computed in step T18 based on the collected data. If it is determined in step T17 that the specified number of data have not been collected, the program goes to step T14.

After computation of the standard deviation in step T18, it is determined in step T19 whether the standard deviation is a stop specified value (dispersion angle: e.g. 0.3 deg) or less. Upon determination that the standard deviation is not more than the stop specified value, the program proceeds to step T20 for the reason that the road condition is satisfactory. In step T20, computation is made of an average value for the data for which it is determined that the standard deviation is not more than the stop specified value. In step T21, it is determined whether the data on the average value is within the normal range or not. If it is determined that the average value data is within the normal range, data on the inclination angle Δα is updated in step T22.

If it is determined in step T19 that the standard deviation is more than the stop specified value, the road condition is judged to be poor, and the program goes to step T25. After acquisition of data on the inclination angle Δα in step T25, processing by the moving average method is performed in step S26 to compute average values, whenever necessary. If it is determined in step T27 that the average values have converged within a predetermined range, the converged average values are stored in memory as convergent average values. In step T28, the amount of change between the maximum value and the minimum value of the convergent average values is computed. After computation of the amount of change in step T28, it is determined in step T29 whether this amount of change is a preset specified value (set amount of change) or more. If the amount of change is judged to be the specified value or larger, a determination is made that a cargo has been loaded or unloaded. Thus, the program goes to step T30, where this amount of change is established as an amount of change for data update. Then, in step T21, a determination of whether the established amount of change is within a normal range or not is made. In step T22, the amount of change is added to (or subtracted from) the current inclination angle Δα data to update the data on the inclination angle Δα.

If it is determined in step T14 that the vehicle speed is not 0 km/h, it is determined in step T31 whether the vehicle speed is a predetermined value or higher. If determinations are made in step T31 that the vehicle speed is not less than the predetermined value, and in step T32 that the acceleration or deceleration of the vehicle is a predetermined value or less, the vehicle is judged to be running. Thus, data on the inclination angle Δα in the running state is acquired in step T33. If it is determined in step T34 that a specified number of (for example, 500) data on the inclination angle Δα have been collected, a standard deviation is computed in step T35 based on the collected data. In step T36, it is determined whether the standard deviation is a driving specified value (dispersion angle: e.g. 0.3 deg) or less. Upon determination that the standard deviation is not more than the driving specified value, computation is made in step T37 of an average value for the data for which it is determined that the standard deviation is not more than the driving specified value. If, in step T21, it is determined that data on the average value is within the normal range, data on the inclination angle Δα is updated in step T22.

Then, similarly to the procedure in the aforementioned embodiment, if it is determined in step T23 that the lamp SW is on, the actuator 21 is driven in step T24 to adjust the light axis of the high intensity bulb 18 to the inclination angle Δα.

With the light axis adjusting apparatus for a vehicle headlamp according to the second embodiment, as described above, if it is determined that the vehicle is stopping, a standard deviation is computed from a specified number of collected data. If this standard deviation is not more than a stop specified value, the road condition is judged to be satisfactory. Based on this judgment, the average value of the data on the inclination angle Δα is used as data for updating the inclination angle Δα. Thus, only data on the inclination angle Δα with few variations can be adopted. If the standard deviation computed from the specified number of collected data is more than the stop specified value, the road condition is judged to be poor. Based on this judgment, the data on the inclination angle Δα are processed by the moving average method, the deviation of the convergent average values is calculated, and this deviation is used as the amount of change. If this amount of change is not less than a specified value, it is determined that loading or unloading of a cargo has taken place, and this amount of change is used as an amount of change for data updating. Thus, data on the inclination angle Δα can be updated swiftly, regardless of the road condition.

Hence, if the situation of the road surface is satisfactory, with the vehicle stopping, the average value of data on the inclination angle Δα measured is simply used for updating purposes. By so doing, processing can be performed easily in a short time. If the situation of the road surface is not satisfactory, loading or unloading is determined by the amount of change in the average values, whereby data on the inclination angle Δα can be updated reliably.

While the present invention has been described in the foregoing fashion, it is to be understood that the invention is not limited thereby, but may be varied in many other ways. Such variations are not to be regarded as a departure from the spirit and scope of the invention, and all such modifications as would be obvious to one skilled in the art are intended to be included within the scope of the appended claims.

What is claimed is:

1. A light axis adjusting apparatus for a vehicle headlamp, comprising:
a light axis adjustor for adjusting a light axis of the headlamp of a vehicle;
an operating state detector for detecting an operating state of the vehicle;
an inclined state detector for detecting an inclined state of the vehicle relative to a road surface;
a change amount computing unit for computing an amount of change of the inclined state during a halt of the vehicle based on results of detection of said inclined state detector when said operating state detector detects a stop state of the vehicle; and
a control device for controlling said light axis adjustor based on the results of detection of said inclined state detector and results of computation of said change amount computing unit.

2. The light axis adjusting apparatus for a vehicle headlamp according to claim 1, wherein
said change amount computing unit includes:
an average value calculator for calculating average values by performing moving average processing of the results of detection of said inclined state detector;
a memory device for storing convergent average values obtained when said average values converge within a predetermined range; and
an inclined state change amount setting device for setting a difference between a maximum value and a minimum value of said convergent average values as said amount of change of the inclined state.

3. The light axis adjusting apparatus for a vehicle headlamp according to claim 2, wherein
said control device includes an updating device for updating the results of detection of said inclined state detector by adding said amount of change to, or subtracting said amount of change from, said results of detection when said amount of change is not less than a set amount of change which has been preset.

4. The light axis adjusting apparatus for a vehicle headlamp according to claim 1, wherein
said operating state detector includes an average value computing unit for computing an average value of the inclined state during driving based on the results of detection of said inclined state detector when said operating state detector detects a driving state of the vehicle, and
said control device controls said light axis adjustor based on the results of detection of said inclined state detector and results of computation of said average value computing unit.

5. The light axis adjusting apparatus for a vehicle headlamp according to claim 4, wherein
said average value computing unit includes:
a collector for collecting a specified number or more of the results of detection of said inclined state detector during driving;
a standard deviation calculator for calculating a standard deviation based on results of collection; and
a setting device for setting an average value of said results of collection as an inclined state average value during driving when said standard deviation is not more than a set standard deviation which has been preset, and
said control device includes an updating device for updating the results of detection of said inclined state detector to said average value.

6. The light axis adjusting apparatus for a vehicle headlamp according to claim 1, further comprising:
a standard deviation calculator for collecting a specified number or more of the results of detection of said inclined state detector and calculating a standard deviation when said operating state detector detects a stop state of the vehicle; and
an average value computing unit which, when said standard deviation has been judged to be not greater than a set standard deviation that has been preset, computes an average value of the results of detection for which said standard deviation has been judged to be not greater than said set standard deviation, and wherein
said control device includes an updating device which updates the results of detection of said inclined state detector to the average value computed by said average value computing unit when said standard deviation is not greater than said set standard deviation, and which adds said amount of change to, or subtracts said amount of change from, the results of detection of said inclined state detector to update said results of detection, when said standard deviation is greater than said set standard deviation.

7. The light axis adjusting apparatus for a vehicle headlamp according to claim 1, wherein
said inclined state detector includes:
an inclination sensor for detecting an inclination angle of the vehicle relative to the road surface; and
a filter device for removing high frequency components of data on the inclination angle detected by said inclination sensor.

8. The light axis adjusting apparatus for a vehicle headlamp according to claim 7, wherein
said inclination sensor is an ultrasonic sensor having a transmitter and a receiver.

9. The light axis adjusting apparatus for a vehicle headlamp according to claim 8, wherein
said transmitter and said receiver are a pair of ultrasonic sensors placed in a vehicle width direction, and a plurality of said pairs of ultrasonic sensors are disposed in a longitudinal direction of the vehicle.

10. The light axis adjusting apparatus for a vehicle headlamp according to claim 7, wherein
said inclined state detector is a laser sensor.

11. The light axis adjusting apparatus for a vehicle headlamp according to claim 1, wherein
said vehicle is a truck furnished with a cab and a frame where said cab is disposed, and
said inclined state detector is placed on said cab or a vehicle front portion of said frame.

12. A light axis adjusting apparatus for a vehicle headlamp, comprising:
light axis adjusting means for adjusting a light axis of the headlamp of a vehicle;
operating state detecting means for detecting an operating state of the vehicle;
inclined state detecting means for detecting an inclined state of the vehicle relative to a road surface;
change amount computing means for computing an amount of change of the inclined state during a halt of the vehicle based on results of detection of said inclined state detecting means when said operating state detecting means detects a stop state of the vehicle; and
control means for controlling said light axis adjusting means based on the results of detection of said inclined state detecting means and results of computation of said change amount computing means.
